(19) United States
(12) Patent Application Publication
(10) Pub. No.: US 2019/0071035 A1
(43) Pub. Date: Mar. 7, 2019

(54) FIXING STRUCTURE FOR EXTERIOR MEMBER AND WIRE HARNESS HAVING THE SAME

(71) Applicant: Yazaki Corporation, Tokyo (JP)

(72) Inventors: Tsukasa SEKINO, Makinohara-shi (JP); Kazuhiro TSUCHIDA, Makinohara-shi (JP); Mitsunobu KATOH, Makinohara-shi (JP); Masaki YOKOYAMA, Makinohara-shi (JP)

(73) Assignee: Yazaki Corporation, Tokyo (JP)

(21) Appl. No.: 16/103,224

(22) Filed: Aug. 14, 2018

(30) Foreign Application Priority Data
Sep. 1, 2017 (JP) 2017-168790

(51) Int. Cl. B60R 16/02; H02G 3/04; H02G 3/06; H02G 3/30; H02G 11/00

(52) U.S. Cl. CPC B60R 16/0215; H02G 3/04; H02G 11/006; H02G 3/30; H02G 3/0616

(57) ABSTRACT

A fixing structure for an exterior member includes: a housing member including a tubular holding portion having an opening end on one end of the tubular holding portion and configured to hold an end portion of a flexible exterior member through which an electric wire is inserted. The holding portion includes: a holding region including a locking rib configured to lock an outer peripheral portion of the exterior member; and a sliding region provided in a portion closer to the opening end than the holding region and configured to slidably hold the exterior member along a longitudinal direction.

### CROSS-REFERENCES TO RELATED APPLICATIONS

This application is based on and claims priority from Japanese Patent Application No. 2017-168790 filed on Sep. 1, 2017, the entire contents of which are incorporated herein by reference.

### FIELD

One or more embodiments of the present invention relate to a fixing structure for an exterior member and to a wire harness having the same.

### BACKGROUND

As a wire harness arranged between a body of a vehicle and a slide door or a back door, there is known a structure in which an exterior member such as a corrugated tube for accommodating a wire bundle is connected to a power feeding part on a body side and a power feeding part on a door side (for example, see JP-A-2015-128366).

### SUMMARY

In the wire harness having the above-described structure, a bending force and a tensile force are concentratedly applied to a portion, which is connected with a housing member of the power feeding part, of the exterior member which is bent each time the door is opened and closed, and the exterior member may be damaged. Therefore, it is necessary to secure sufficient strength by thickening the exterior member, for example. As a result, cost of the exterior member is increased.

One or more embodiments of the present invention have been made in view of the above circumstances, and an object thereof is to provide a fixing structure for an exterior member capable of improving durability by suppressing concentration of a load on an exterior member connected to a housing member and to provide a wire harness including the fixing structure for the exterior member.

The above object according to one or more embodiments of the present invention is achieved by the following configurations.

(1) A fixing structure for an exterior member including: a housing member including a tubular holding portion having an opening end on one end of the tubular holding portion and configured to hold an end portion of a flexible exterior member through which an electric wire is inserted, wherein the holding portion includes: a holding region including a locking rib configured to lock an outer peripheral portion of the exterior member; and a sliding region provided in a portion closer to the opening end than the holding region and configured to slidably hold the exterior member along a longitudinal direction.

According to the fixing structure for the exterior member of (1), when an external force such as a bending force or a tensile force is applied to the exterior member due to relative displacement between the exterior member and the housing member, vicinity of the end portion of the exterior member, which is arranged in the sliding region provided on the opening end side of the holding portion in the housing member, displaces in the longitudinal direction. Therefore, when the external force is applied to the exterior member, the external force does not concentrate on only a portion near the holding portion in the housing member, but dispersed in the sliding region of the holding portion. Therefore, concentration of the external force on a connection end of the exterior member which is connected to the holding portion of the housing member can be reduced, and the exterior member can be protected.

(2) The fixing structure for the exterior member according to (1), wherein the holding portion includes a chamfered portion formed on an inner periphery of the opening end.

According to the fixing structure for the exterior member of (2), the chamfered portion is provided on the inner periphery at the opening end of the holding portion, so that damage to the exterior member by contact with the opening end of the holding portion at an inner side of the bending can be suppressed when a bending force is applied to the exterior member.

(3) A wire harness including a power feeding part including: the housing member of the fixing structure for the exterior member according to (1) or (2); and a fixed member configured to rotatably support the housing member, and to be fixed to a structure body which is relatively displaced with respect to the exterior member, wherein the power feeding part is attached to the end portion of the exterior member through which the electric wire is inserted.

According to the wire harness of (3), the wire harness with excellent durability is provided in which concentration of the bending force and the tensile force on a portion of the exterior member which is connected with the housing member of the power feeding part is suppressed.

(4) A wire harness including: the housing member of the fixing structure for the exterior member according to (1) or (2), wherein the housing member is attached to the end portion of the exterior member through which the electric wire is inserted

According to the wire harness of (4), the wire harness with excellent durability is provided in which concentration of the bending force and the tensile force on a portion of the exterior member which is connected with the holding portion of the housing member such as a protector is suppressed.

According to one or more embodiments of the present invention, there is provided a fixing structure for an exterior member capable of improving durability by suppressing concentration of a load on an exterior member connected to a housing member, and a wire harness including the fixing structure for the exterior member.

One or more embodiments of the present invention have been briefly described above. Further, details will be clarified by reading embodiments of the invention described below with reference to attached drawings.

### BRIEF DESCRIPTION OF DRAWINGS

FIG. 1 is a perspective view of a wire harness including a power feeding part having a housing member configuring a fixing structure for an exterior member according to one embodiment of the present invention.

FIG. 2 is a perspective view of the housing member configuring the fixing structure for the exterior member show in FIG. 1.

FIG. 3 is a perspective view in which the housing member shown in FIG. 2 is divided in a vertical direction.

FIG. 4 is a cross-sectional view along the vertical direction of the housing member shown in FIG. 3.

FIG. 5A and FIG. 5B are views showing states of an exterior member connected to the housing member configuring the fixing structure for the exterior member according to the embodiment, in which FIG. 5A and FIG. 5B are cross-sectional views along the vertical direction.

FIG. 6 is a cross-sectional view along a vertical direction of a housing member of a power feeding part configuring a fixing structure for an exterior member according to a reference example.

FIG. 7A and FIG. 7B are views showing states of the exterior member connected to the housing member of the power feeding part configuring the fixing structure for the exterior member according to the reference example, in which FIG. 7A and FIG. 7B are cross-sectional views along a vertical direction.

FIG. 8 is a cross-sectional view of main parts along a vertical direction of a wire harness including a housing member configuring a fixing structure for an exterior member according to another embodiment of the present invention.

FIG. 9 is a cross-sectional view of the main parts along the vertical direction of the housing member shown in FIG. 8.

### DETAILED DESCRIPTION

Hereinafter, embodiments according to the present invention will be described with reference to the drawings.

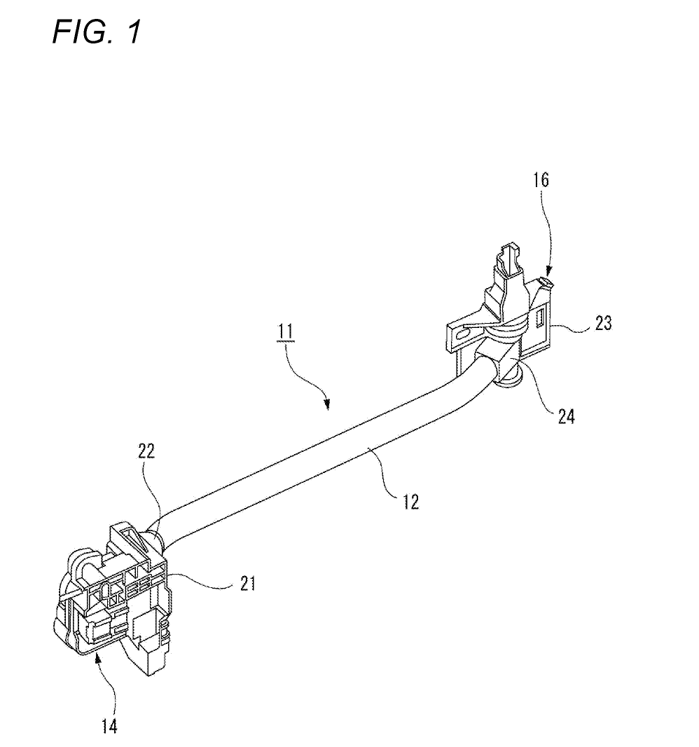

FIG. 1 is a perspective view of a wire harness 11 including a power feeding part having inner members 22, 24 configuring a fixing structure for an exterior member according to one embodiment of the present invention.

As shown in FIG. 1, the wire harness 11 according to the embodiment is provided with a vehicle body side power feeding part 14 as a power feeding part on a vehicle body side at one end side, and a door side power feeding part 16 as a power feeding part on a door side at the other end side. The wire harness 11 is arranged between a vehicle body (structure body) of a vehicle such as an automobile and a slide door (structure body) which is slidable with respect to the vehicle body. The vehicle body side power feeding part 14 of the wire harness 11 is assembled to the vehicle body, and the door side power feeding part 16 of the wire harness 11 is assembled to the slide door.

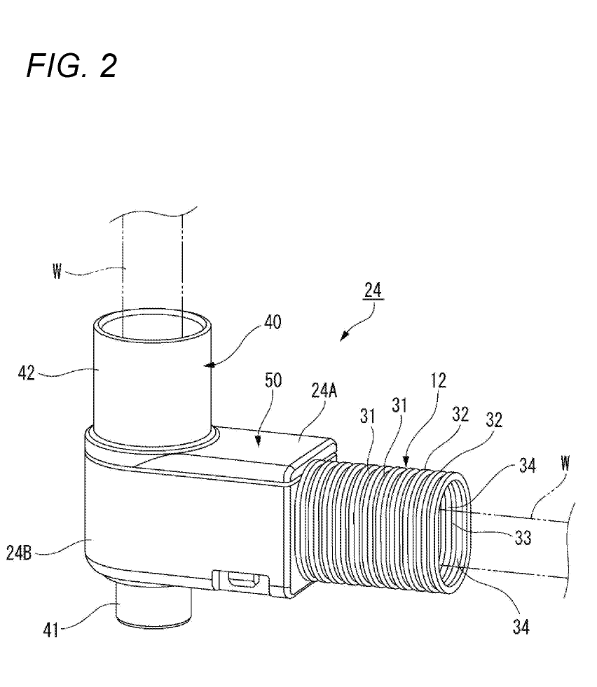

The wire harness 11 is provided so as to supply power to various electrical components, auxiliary machines or the like provided on the door side, or to transmit and receive a signal between electrical components, auxiliary machines or the like provided on the vehicle body side and the door side. The wire harness 11 according to the present embodiment includes a wire bundle W (see FIG. 2) configured by a plurality of electric wires, and the wire bundle W is passed through a flexible tubular exterior member 12 so as to be protected.

The vehicle body side power feeding part 14 includes an outer member (fixed member) 21 made of a synthetic resin which is fixed to the vehicle body, and an inner member (housing member) 22 made of a synthetic resin which is pivotally supported by the outer member 21 so as to be rotatable (swingable) about a vertical direction. Similarly, the door side power feeding part 16 includes an outer member (fixed member) 23 made of a synthetic resin which is fixed to the slide door, and an inner member (housing member) 24 which is pivotally supported by the outer member 23 so as to be rotatable (swingable) about the vertical direction. One end of the exterior member 12 with the wire bundle W inserted therethrough is connected to the inner member 22 of the vehicle body side power feeding part 14 and the other end of the exterior member 12 is connected to the inner member 24 of the door side power feeding part 16.

In the vehicle body side power feeding part 14 and the door side power feeding part 16, when the slide door is opened and closed, the inner member 22 and the inner member 24, which are the housing members to which both end portions of the exterior member 12 are connected, rotate about a vertical axis separately according to movement of the exterior member 12 of the wire harness 11. Therefore, excessive bending at both end portions of the wire harness 11 is suppressed when the door is opened and closed.

Next, structures of the inner member 22 of the vehicle body side power feeding part 14 and the inner member 24 of the door side power feeding part 16 to which the exterior member 12 is connected will be described. Since the inner members 22 and 24 have substantially the same structure, the inner member 24 of the door side power feeding part 16 will be exemplified and explained.

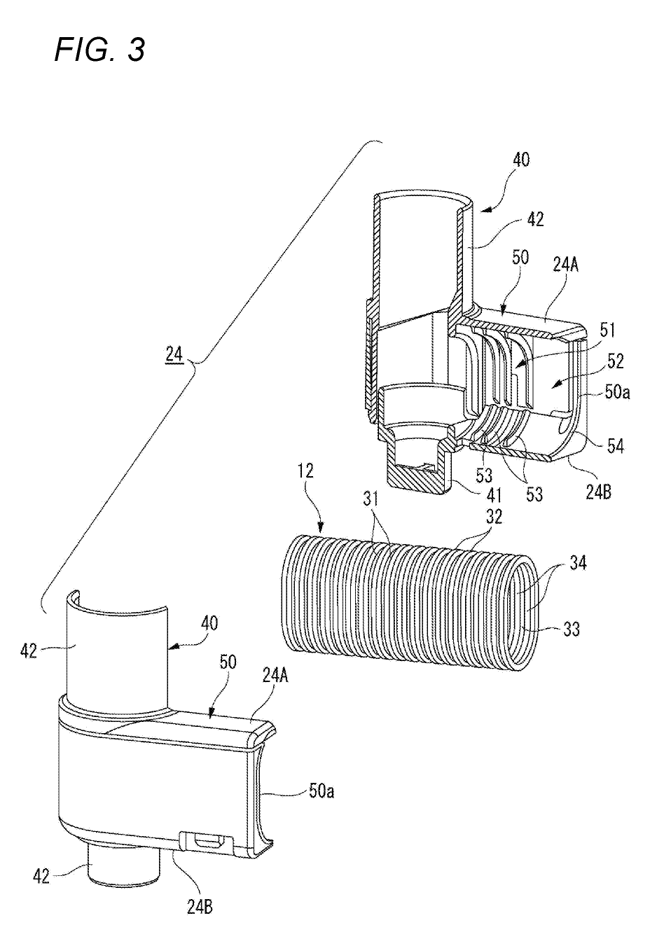

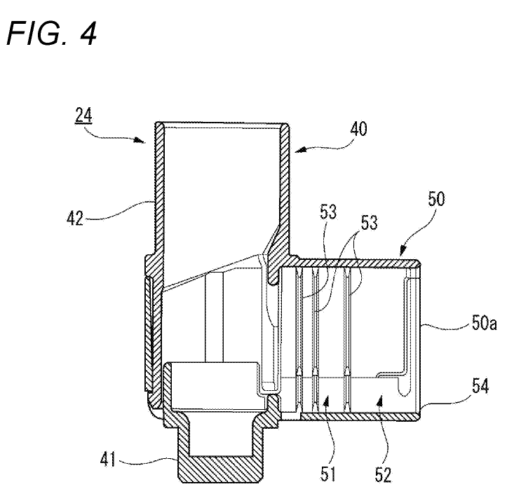

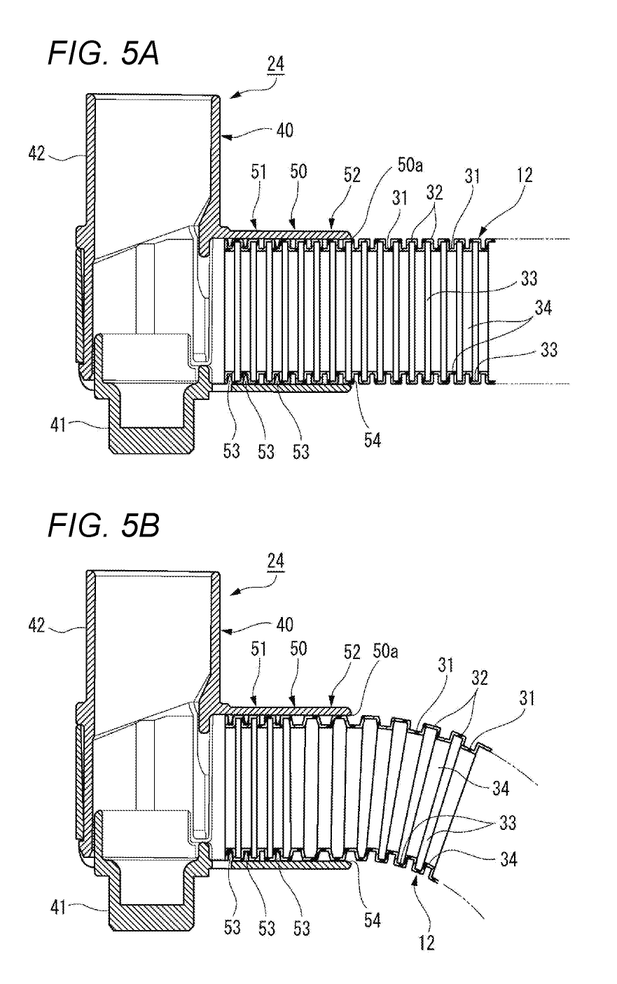

FIG. 2 is a perspective view of the inner member 24 configuring the fixing structure for the exterior member show in FIG. 1. FIG. 3 is a perspective view in which the inner member 24 shown in FIG. 2 is divided in the vertical direction. FIG. 4 is a cross-sectional view along the vertical direction of the inner member 24 shown in FIG. 3. FIG. 5A and FIG. 5B are views showing states of the exterior member 12 connected to the inner member 24 configuring the fixing structure for the exterior member according to the present embodiment, in which FIG. 5A and FIG. 5B are cross-sectional views along the vertical direction.

As shown in FIG. 2 and FIG. 3, the exterior member 12 is a tubular member made of an electric insulating synthetic resin and is formed in a bellows shape so as to be easily bendable. Specifically, the exterior member 12 is configured by a flexible corrugated tube with a continuous hollow tubular bellows shape. A plurality of valley portions 31 formed in a peripheral direction and a plurality of mountain portions 32 formed in the peripheral direction are alternately and continuously provided along a longitudinal direction on an outer peripheral surface of the exterior member 12. Further, a plurality of valley portions 33 formed in a peripheral direction and a plurality of mountain portions 34 formed in the peripheral direction are alternately and continuously provided along a longitudinal direction on an inner peripheral surface of the exterior member 12. In the exterior member 12, an inner peripheral side of a portion corresponding to a position where the mountain portion 32 is formed on the outer peripheral surface is the valley portion 33, and an inner peripheral side of a portion corresponding to a position where the valley portion 31 is formed on the outer peripheral surface is the mountain portion 34.

The inner member 24 according to the present embodiment includes a rotating portion 40 and a holding portion 50. The inner member 24 is configured by upper and lower divided portions 24A, 24B, and the rotating portion 40 and the holding portion 50 are formed by combining the upper and lower divided portions 24A, 24B.

The rotating portion 40 includes a bottomed cylindrical support pin portion 41 protruded on a lower side and a cylindrical support tube portion 42 protruded on an upper side. The cylindrical support pin portion 41 and the support tube portion 42 of the rotating portion 40 in the inner member 24 are supported by a bearing portion (not shown) of the outer member 23. Therefore, the inner member 24 is supported so as to be swingable about the vertical axis with respect to the outer member 23 as the fixing member fixed to the slide door which is relatively displaced with respect to the exterior member 12. The holding portion 50 is formed in a tubular shape and is extended laterally from the rotating portion 40. The holding portion 50 holds a state where an end portion of the exterior member 12 is inserted therein. The wire bundle W passing through the exterior member 12 passes the inner member 24 and is drawn out from the support tube portion 42 of the rotating portion 40.

As shown in FIG. 4, the holding portion 50 includes a holding region 51 and a sliding region 52. The holding region 51 includes a plurality of locking ribs 53 on an inner peripheral surface thereof. The locking ribs 53 are formed in a peripheral direction and are formed with an interval in an axial direction (a left right direction in FIG. 4) of the holding portion 50. The locking ribs 53 enter the valley portions 31 on an outer peripheral side of the exterior member 12 so as to lock the exterior member 12. The sliding region 52 is provided on an opening end 50a side of the holding portion 50 with respect to the holding region 51. The sliding region 52 has an inner shape larger than an outer shape of the exterior member 12. The sliding region 52 slidably holds the exterior member 12 along the longitudinal direction. Further, the holding portion 50 includes a circular arc or taper shaped chamfered portion 54 formed on an inner periphery of the opening end 50a.

As shown in FIG. 5A, one end portion of the exterior member 12 is inserted and held in the holding portion 50. The locking rib 53 of the holding region 51 enters, in the peripheral direction, the valley portion 31 on the outer peripheral side at the end portion of the exterior member 12. Therefore, the end portion is locked by the locking rib 53 so that the exterior member 12 is held at the holding region 51 of the holding portion 50. Vicinity of the end portion of the exterior member 12 is arranged in the sliding region 52 of the holding portion 50.

As shown in FIG. 5B, the vicinity of the end portion of the exterior member 12, which is arranged in the sliding region 52 provided on the opening end 50a side of the holding portion 50, can slide in the longitudinal direction in a state where movement in a radial direction is restricted. Therefore, when an external force such as a bending force or a tensile force is applied to the exterior member 12 in accordance with opening and closing of the slide door, the vicinity of the end portion of the exterior member 12 is expanded and contracted within the sliding region 52 of the holding portion 50.

Here, an inner member 60 of a door side power feeding part configuring a fixing structure for an exterior member according to the reference example is described.

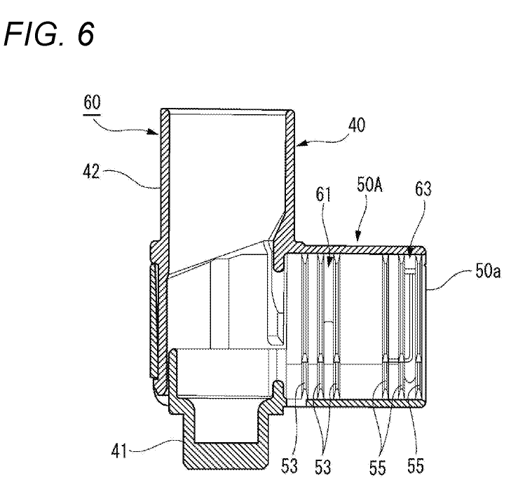

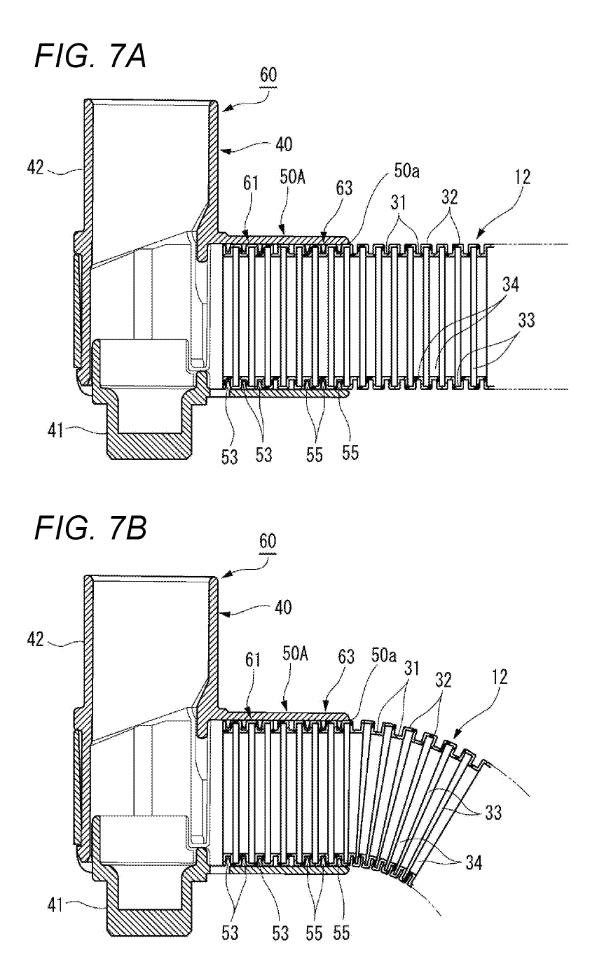

FIG. 6 is a cross-sectional view along a vertical direction of the inner member 60 of the door side power feeding part configuring the fixing structure for the exterior member according to the reference example. FIG. 7A and FIG. 7B are views showing states of the exterior member 12 connected to the inner member 60 of the door side power feeding part configuring the fixing structure for the exterior member according to the reference example, in which FIG. 7A and FIG. 7B are cross-sectional views along the vertical direction.

As shown in FIG. 6, in the inner member 60 of the door side power feeding part according to the reference example, a plurality of locking ribs 53 and 55 are respectively formed on an inner peripheral surface of a region 61 on a rotating portion 40 side of a holding portion 50A and an inner peripheral surface of a region 63 on an opening end 50a side of the holding portion 50A.

As shown in FIG. 7A, in the inner member 60 configuring the fixing structure for the exterior member according to the reference example, the valley portions 31 on the outer peripheral side at the end portion of the exterior member 12 enter the locking ribs 53 and 55 which are respectively formed on the inner peripheral surface of the region 61 on the rotating portion 40 side of a holding portion 50A and the inner peripheral surface of the region 63 on the opening end 50a side of the holding portion 50A. Therefore, the exterior member 12 is locked by the locking ribs 53 and 55, and is held substantially over an entire region (region 61 and region 63) including the opening end 50a side of the holding portion 50A.

As shown in FIG. 7B, in the inner member 60 configuring the fixing structure for the exterior member according to the reference example, displacement in a longitudinal direction is restricted over substantially an entire length in an axial direction (a left right direction in FIG. 7A and FIG. 7B) of the holding portion 50A. Therefore, when an external force such as a bending force or a tensile force is applied to the exterior member 12 in accordance with opening and closing of the slide door, the exterior member 12 is subjected to the external force concentratedly applied to a portion (opening end 50a) near the holding portion 50A.

On the contrary, according to the inner member 24 of the door side power feeding part 16 configuring the fixing structure for the exterior member of the present embodiment, when the external force such as a bending force or a tensile force is applied to the exterior member 12, the vicinity of the end portion of the exterior member 12, which is arranged in the sliding region 52 provided on the opening end 50a side of the holding portion 50 in the inner member 24, can slide in the longitudinal direction. Therefore, when the external force is applied to the exterior member 12, the external force does not concentrate on only the portion (opening end 50a) near the holding portion 50 in the inner member 24, but dispersed in the sliding region 52 of the holding portion 50.

In this way, according to the inner member 24 of the door side power feeding part 16 configuring the fixing structure for the exterior member of the present embodiment, concentration of the external force on a connection end of the exterior member 12 which is connected to the holding portion 50 of the inner member 24 can be reduced, and the exterior member 12 can be protected. As a result, it is not necessary to thicken the exterior member 12 so as to increase strength thereof, and cost increase of the exterior member 12 can be suppressed.

Further, according to the fixing structure for the exterior member of the present embodiment, the chamfered portion 54 is provided on the inner periphery at the opening end 50a of the holding portion 50, so that damage to the exterior member 12 by contact with the opening end 50a of the holding portion 50 at an inner side of the bending can be suppressed when a bending force is applied to the exterior member 12.

According to the wire harness 11 of the present embodiment, the door side power feeding part 16 is attached to the end portion of the exterior member 12 through which the wire bundle W is inserted, so that the wire harness 11 with excellent durability is provided in which concentration of the bending force and the tensile force on a portion of the exterior member 12 which is connected with the inner member 24 of the door side power feeding part 16 is suppressed.

Incidentally, in the above embodiment, a case where the fixing structure for the exterior member of the present invention is applied to the inner member 24 of the door side power feeding part 16 is explained as an example. However, the fixing structure for the exterior member of the present invention may also be applied to the inner member 22 of the vehicle body side power feeding part 14. In this case, concentration of the external force at a connection end of the exterior member 12 which is connected to the inner member 22 of the vehicle body side power feeding part 14 can be reduced, and the exterior member 12 can be protected.

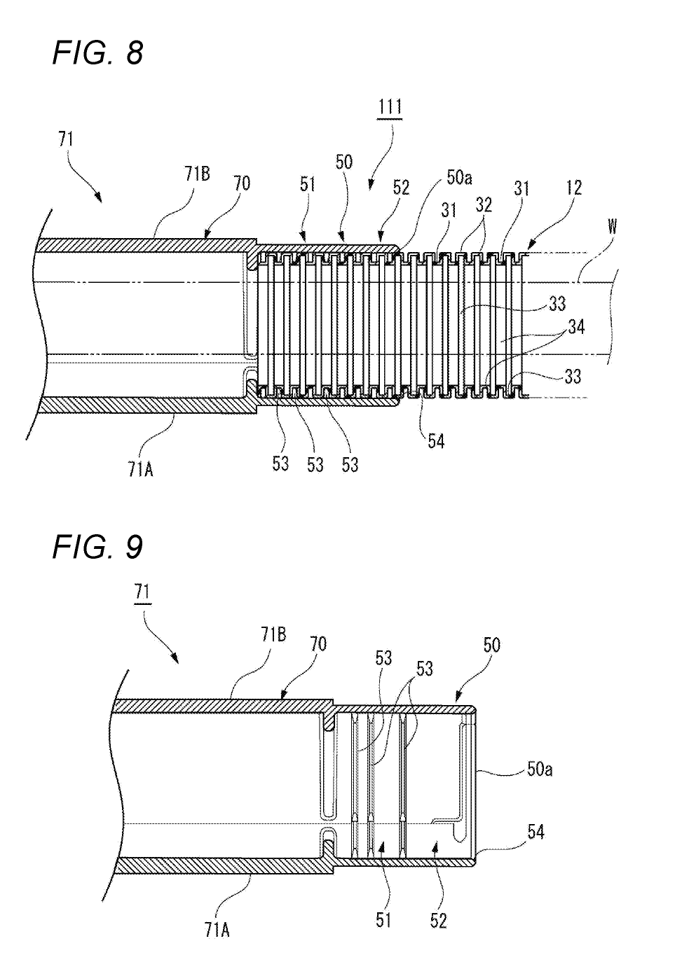

FIG. 8 is a cross-sectional view of main parts along a vertical direction of a wire harness 111 including a protector 71 configuring a fixing structure for an exterior member according to another embodiment of the present invention. FIG. 9 is a cross-sectional view of the main parts along the vertical direction of the protector 71 shown in FIG. 8.

As shown in FIG. 8, the wire harness 11 according to the present embodiment includes a wire bundle W which supplies power to various electrical components, auxiliary machines or the like provided on a vehicle body of a vehicle such as an automobile, or transmits and receives a signal; an exterior member 12 which protects the wire bundle W arranged on the vehicle body; and a protector 71 which is fixed to the vehicle body and accommodates and protects the wire bundle W.

The protector 71 according to the present embodiment is a housing member including a main body portion 70 and a holding portion 50. The protector 71 is configured by a case 71A accommodating the wire bundle W and a cover 71B covering an opening of the case 71A. The main body portion 70 and the holding portion 50 are formed by combining the case 71A and the cover 71B.

The main body portion 70 has an elongated outer shape corresponding to a mounting portion of the vehicle body to be fixed, and is fixed to the vehicle body via a clip portion or a mounting bracket which are not shown. 70The holding portion 50 is formed in a tubular shape and is extended from one end portion of the main body portion in a longitudinal direction. The holding portion 50 holds a state where an end portion of the exterior member 12 is inserted therein. The wire bundle W passing through the exterior member 12 passes the main body portion 70 and is drawn out from the other end portion of the main body portion 70.

As shown in FIG. 9, the holding portion 50 includes a holding region 51 and a sliding region 52. The holding region 51 includes a plurality of locking ribs 53 on an inner peripheral surface thereof. The locking ribs 53 are formed in a peripheral direction and are formed with an interval in an axial direction (a left right direction in FIG. 9) of the holding portion 50. The locking ribs 53 enter valley portions 31 on an outer peripheral side of the exterior member 12 so as to lock the exterior member 12. The sliding region 52 is provided on an opening end 50a side of the holding portion 50 with respect to the holding region 51. The sliding region 52 has an inner shape larger than an outer shape of the exterior member 12. The sliding region 52 slidably holds the exterior member 12 along the longitudinal direction. Further, the holding portion 50 includes a circular arc or taper shaped chamfered portion 54 formed on an inner periphery of the opening end 50a.

As shown in FIG. 8, one end portion of the exterior member 12 is inserted and held in the holding portion 50. The locking rib 53 of the holding region 51 enters, in the peripheral direction, the valley portion 31 on the outer peripheral side at the end portion of the exterior member 12. Therefore, the end portion is locked by the locking rib 53 so that the exterior member 12 is held at the holding region 51 of the holding portion 50. Vicinity of the end portion of the exterior member 12 is arranged in the sliding region 52 of the holding portion 50.

The vicinity of the end portion of the exterior member 12, which is arranged in the sliding region 52 provided on the opening end 50a side of the holding portion 50, can slide in the longitudinal direction in a state where movement in a radial direction is restricted. Therefore, when an external force such as a bending force or a tensile force is applied to the exterior member 12, the vicinity of the end portion of the exterior member 12 is expanded and contracted within the sliding region 52 of the holding portion 50.

Therefore, according to the protector 71 configuring the fixing structure for the exterior member of the present embodiment, when the external force such as a bending force or a tensile force is applied to the exterior member 12 due to relative displacement between the exterior member 12 and the protector 71, the vicinity of the end portion of the exterior member 12, which is arranged in the sliding region 52 provided on the opening end 50a side of the holding portion 50 in the protector 71, can slide in the longitudinal direction. Therefore, when the external force is applied to the exterior member 12, the external force does not concentrate on only a portion (opening end 50a) near the holding portion 50 in the protector 71, but dispersed in the sliding region 52 of the holding portion 50.

In this way, according to the protector 71 of the present embodiment, concentration of the external force on a connection end of the exterior member 12 which is connected to the holding 50 of the protector 71 can be reduced, and the exterior member 12 can be protected. As a result, it is not necessary to thicken the exterior member 12 so as to increase strength thereof, and cost increase of the exterior member 12 can be suppressed.

According to the wire harness 111 of the present embodiment, the protector 71 is attached to the end portion of the exterior member 12 through which the wire bundle W is inserted, so that the wire harness 111 with excellent durability is provided in which concentration of the bending force and the tensile force on a portion of the exterior member 12 which is connected with the protector 17 is suppressed.

The fixing structure for the exterior member according to the present invention is not limited as the housing member applied to the inner members 22, 24 and the protector 71 described above, but also can be various housing members applied to an electric connection box or the like that includes a cover which fixes the exterior member 12 to a connector housing, or an electric wire drawing-out portion to which the exterior member 12 is connected.

Incidentally, the present invention is not limited to the above-described embodiments, but may be appropriately modified, improved or the like. In addition, materials, shapes, dimensions, numbers, arrangement places or the like of the constituent elements in the above-described embodiments are arbitrary and not limited as long as the present invention can be achieved.

Further, characteristics of the embodiments of the fixing structure for the exterior member as well as the wire harness according to the present invention described above are summarized briefly in the following items <1> to <4>, respectively.

<1> A fixing structure for an exterior member including:

a housing member (inner members 22, 24; protector 71) including a tubular holding portion (50) having an opening end (50a) on one end of the tubular holding portion (50) and configured to hold an end portion of a flexible exterior member (12) through which an electric wire (a wire bundle W) is inserted,

wherein the holding portion (50) includes:
a holding region (51) including a locking rib (53) configured to lock an outer peripheral portion of the exterior member (12); and
a sliding region (52) provided in a portion closer to the opening end (50a) than the holding region (51) and configured to slidably hold the exterior member (12) along a longitudinal direction.

<2> The fixing structure for the exterior member according to <1>,

wherein the holding portion (50) includes a chamfered portion (54) formed on an inner periphery of the opening end (50a).

<3> A wire harness (11) including:

a power feeding part (vehicle body side power feeding part 14, door side power feeding part 16) including:
the housing member (inner members 22, 24) of the fixing structure for the exterior member according to <1> or <2>; and
a fixed member (outer members 21, 23) configured to rotatably support the housing member (inner members 22, 24), and to be fixed to a structure body which is relatively displaced with respect to the exterior member (12),

wherein the power feeding part (vehicle body side power feeding part 14, door side power feeding part 16) is attached to the end portion of the exterior member (12) through which the electric wire (the wire bundle W) is inserted.

<4> A wire harness (111) including:

the housing member (71) of the fixing structure for the exterior member according to <1> or <2>,

wherein the housing member (71) is attached to the end portion of the exterior member (12) through which the electric wire (the wire bundle W) is inserted.

1. A fixing structure for an exterior member comprising:
a housing member comprising a tubular holding portion having an opening end on one end of the tubular holding portion and configured to hold an end portion of a flexible exterior member through which an electric wire is inserted,
wherein the holding portion comprises:
a holding region including a locking rib configured to lock an outer peripheral portion of the exterior member; and
a sliding region provided in a portion closer to the opening end than the holding region and configured to slidably hold the exterior member along a longitudinal direction.

2. The fixing structure for the exterior member according to claim 1, wherein the holding portion comprises a chamfered portion formed on an inner periphery of the opening end.

3. A wire harness comprising:
a power feeding part comprising:
the housing member of the fixing structure for the exterior member according to claim 1; and
a fixed member configured to rotatably support the housing member, and to be fixed to a structure body which is relatively displaced with respect to the exterior member,
wherein the power feeding part is attached to the end portion of the exterior member through which the electric wire is inserted.

4. A wire harness comprising:
the housing member of the fixing structure for the exterior member according to claim 1,
wherein the housing member is attached to the end portion of the exterior member through which the electric wires are inserted.
